(19) United States
(12) Patent Application Publication
(10) Pub. No.: US 2018/0141303 A1
(43) Pub. Date: May 24, 2018

(54) LWRT MATERIAL WITH OUTER LAYER THAT WILL NOT ADHERE TO PRESS MOLDS, AND AUTOMOTIVE COMPONENT MADE OF SUCH LWRT MATERIAL

(71) Applicant: Röchling Automotive SE & Co. KG, Mannheim (DE)

(72) Inventors: Klaus Pfaffelhuber, Augsburg (DE); Alexander Schwarz, Worms (DE); René Falk, Achern (DE)

(21) Appl. No.: 15/814,045

(22) Filed: Nov. 15, 2017

(30) Foreign Application Priority Data
Nov. 22, 2016 (DE) 10 2016 223 030.1

(51) Int. Cl. B32B 5/10; B32B 5/02; B32B 27/08; B32B 27/12; B32B 27/32; B32B 27/34; B32B 27/36; B60R 13/08

(52) U.S. Cl. CPC B32B 5/10; B32B 5/028; B32B 27/08; B32B 27/12; B32B 27/32; B32B 27/34; B32B 2605/08; B60R 13/0861; B32B 2262/0284; B32B 2262/04; B32B 2262/10; B32B 2305/07; B32B 2307/718; B32B 27/36

(57) ABSTRACT

An LWRT material having a core layer that includes thermoplastically bound structural fibers, and having at least one outer layer that likewise includes thermoplastically bound structural fibers, the outer layer also having bicomponent fibers as structural binder fibers, each of which has a fiber core made of a fiber core material with a predetermined fiber core melting or fiber core softening temperature, and a sheath surrounding the fiber core radially and made of a thermoplastic sheath material with a predetermined sheath melting or sheath softening temperature, the sheath melting or sheath softening temperature being lower than the fiber core melting or fiber core softening temperature, and the sheaths of the bicomponent fibers contributing to the thermoplastic binding of fibers in the outer layer.

The present invention relates to an LWRT material having a core layer that comprises thermoplastically bound structural fibers, and having at least one outer layer that likewise comprises thermoplastically bound structural fibers.

The present invention further relates to an automotive component, in particular a shielding component such as an underbody shield or a fender skirt, comprising such an LWRT material.

### BACKGROUND OF THE INVENTION

LWRT materials, or low-weight fiber-reinforced thermoplastic materials (“LWRT”=“Low Weight Reinforced Thermoplast”), are known for use in automotive engineering. These materials typically have a core layer, which is more or less porous depending upon its degree of compaction, and an outer layer, which is indirectly or directly connected to the at least one outer surface of said core layer.

The core layer is typically formed from a tangled web of fibers bound in situ by a thermoplastic matrix. The thermoplastic matrix generally does not fill in all of the space between the fibers of the tangled fiber web, giving the core layer a certain degree of porosity. The porosity of the core layer or of the LWRT material can be adjusted by compaction during production.

A common material mixture for the core layer comprises glass fibers, thermoplastically bound by a polyolefin, in particular polypropylene.

The core layer is typically formed from a fiber mixture comprising structural fibers made of a material with a high melting point or softening temperature, which provide the structure of the core layer, and binder fibers made of a material with a lower melting point or softening temperature than the material of the structural fibers, which provide the thermoplastic bonding of the structural fibers.

During processing, the fiber mixture is heated to a temperature that is between the melting or softening temperature of the binder fibers and the melting or softening temperature of the structural fibers, so that the binder fibers are melted to a flowable mass that wets the structural fibers, and binds these fibers once the original material mixture has cooled.

This may be followed by additional processing steps such as lofting, compacting, etc.

Outer layers known from the prior art are generally similar in construction to the core layer, although the outer layers typically have a lower weight per unit area than the core layer, and the weight percentages of binder material and structural fibers may deviate from the weight percentages present in the core layer.

Once the binder fibers in the core and outer layers have been fully melted and then cooled again, the binder material is no longer in its original fibrous state, but is present as a plastic matrix, which is more or less porous depending upon the degree of compaction of the LWRT material.

It is a disadvantage of the known LWRT material of the prior art that melting the binder fibers, particularly in the outermost outer layer, leads to an uncontrolled flow of binder material into the pores and cavities formed by the tangled web of structural fibers in the outer layer, thereby allowing some melted and thus flowable binder material to escape through the outer layer. When the known LWRT material is processed, this escaped binder material can result in undesirable adhesion or bonding of the LWRT outer layer to heating plates or to heated machining tools in general.

Current efforts to avoid this undesirable adhesion of the outer layer to surfaces of tools that are used in processing the LWRT material are focused on positioning an intermediate layer between the tool and the outer layer. For example, protection fleeces may be placed between the outer layer of the LWRT material and contact heating tools for this purpose.

Although such intermediate layers can prevent or at least reduce the adhesion of LWRT material, in particular the outer layer thereof, to machining tools, the provision of such intermediate layers, which then remain part of the finished LWRT component, undesirably increases the cost and the weight of such components.

### SUMMARY OF THE INVENTION

It is therefore an object of the present invention to further develop an LWRT material of the type in question such that its tendency to adhere to machining tools, in particular to contact heaters, is at least reduced or even completely eliminated without an intermediate layer, while maintaining the same mechanical properties, such as stiffness.

This object and others is achieved according to the invention by an LWRT material of the type mentioned at the outset, in which the outer layer comprises bicomponent fibers as structural binder fibers, each of which comprises a fiber core made of a fiber core material with a predetermined fiber core melting or fiber core softening temperature, and a sheath made of a thermoplastic sheath material with a predetermined sheath melting or sheath softening temperature, which encases the fiber core radially on its exterior, the sheath melting or sheath softening temperature being lower than the fiber core melting or fiber core softening temperature, and the sheaths of the bicomponent fibers contributing to the thermoplastic binding of fibers in the outer layer.

In contrast to known outer layers, in which the structural fibers are bound solely by a thermoplastic matrix, in the outer layer of the LWRT material of the invention, bicomponent fibers provide for both the structure of the outer layer and the thermoplastic binding between fibers of the outer layer. The bicomponent fibers are therefore referred to as structural binder fibers. These structural binder fibers include the aforementioned fiber core with the associated fiber core material as a structure-forming portion, and the sheath made of the aforementioned sheath material, encasing the core of each fiber as a binding portion.

These structural binder fibers can likewise be processed, more particularly thermoplastically bound, using the same processes that are known for use with LWRT materials that have conventional outer layers, by heating the fibers to a temperature level between the sheath melting or sheath softening temperature and the fiber core melting or fiber core softening temperature.

The advantage of the LWRT material of the invention is that, although the sheath of the bicomponent fiber becomes molten when heated above the sheath melting temperature, it still wets substantially the entire fiber core, and therefore substantially retains its sleeve-like shape. As a result, in contrast to the process of matrix formation in conventional outer layers, during the bond-forming heating and subsequent recooling of the LWRT material of the invention, no thermoplastic binder material escapes through the outer layer, or escapes only in negligible amounts at isolated points. In any event, owing to the reduced or even eliminated escape of thermoplastic binder material from the fiber structure of the outer layer, the tendency of the LWRT material of the invention to adhere to tools that are used for machining the LWRT material, in particular contact heating tools, can be decreased to virtually zero. The adhesion-preventing intermediate layer that previously was necessary can thus be dispensed with, and the LWRT material can be provided with substantially the same performance characteristics, but with a lower weight per unit area, and thus at a lower cost.

In the present application, when a comparison of the fiber core melting or fiber core softening temperature with a sheath melting or sheath softening temperature is referenced, it is assumed that similar temperatures are being compared with one another, i.e. either the melting temperatures or the softening temperatures are compared with one another.

A fiber core for the purposes of the present invention is also considered to have a higher fiber core melting or softening temperature than the sheath material if the fiber core material is destroyed as heating increases, for example by charring or combustion, without transitioning into a flowable or softened phase. It is essential only for the material of the fiber core to be dimensionally stable at temperatures at which the sheath material is already softened or melted.

The fiber core material can therefore be selected from appropriately thermally stable materials, for example polyester, in particular polyethylene terephthalate, polyacrylonitrile, in particular oxidized polyacrylonitrile, cellulose, in particular viscose, polyetheretherketone, polystyrene, glass, quartz, stone, silica and metal. The fiber core material is preferably only one of the aforementioned materials, although it is also possible for the fiber core material to be a material composite of a plurality of the aforementioned materials.

Accordingly, thermoplastics that have a melting temperature lower than that of the associated fiber core material are suitable for use as the sheath material. Suitable sheath materials therefore include the following (not an exhaustive list): polyolefin, polyamide and polylactate. In the interest of lower costs and improved processability, polyolefins, in particular polypropylene, are preferred as sheath materials.

Also suitable for use as the sheath material are copolymers that contain a copolymer of one of the thermoplastic polymers listed as a fiber core material, for example a copolymer of polyethylene terephthalate.

In the automotive industry, the decisive temperature limit is generally about 220° C. Therefore, materials that are dimensionally stable at 220° C. will generally be selected as fiber core materials, while materials that melt at temperatures below 220° C. will generally be selected as sheath materials. This enables LWRT materials that are more operationally reliable for automotive applications to be produced.

Since it is currently understood that matrix formation is responsible for the undesirable adhesion tendency of known outer layers of prior art LWRT materials, the outer layer of the LWRT material of the invention preferably has no thermoplastic binder material matrix.

The fibers of the outer layer are therefore preferably thermoplastically bound solely by sheaths of bicomponent fibers that are fused together.

In principle, the outer layer can actually consist solely of said bicomponent fibers as structural binder fibers. However, this is not necessary for providing a stable, durable outer layer on the LWRT material. It is actually sufficient for only a certain proportion of the fibers in the outer layer to be the above-mentioned structural binder fibers, and for the outer layer to further contain additional, for example single-component fibers, which are bonded to the sheaths by the melting thereof.

An automotive component containing an LWRT material as discussed herein can be stable and durable as long as at least 10% by weight of the fiber weight contained in the outer layer is structural binder fibers.

Since the structure of the bicomponent fibers, which is more complex than that of ordinary single-component fibers, may make them more expensive by weight than fibers typically used in prior art outer layers, the cost increase of producing the outer layer discussed herein can be limited by limiting the structural binder fiber content in the outer layer to no more than 60% by weight, preferably no more than 50% by weight. This percentage by weight of structural binder fibers is sufficient to reliably produce even highly durable automotive components from the LWRT material discussed herein.

The remaining fibers can then be single-component fibers, for example glass fibers or polyester fibers. For the fibers other than structural binder fibers that are contained in the outer layer, generally any material that is also suitable for use as a fiber core material may be used.

Tests have shown that the outer layers bound by the dual-component structural binder fibers offer highly effective mechanical protection properties for protecting the core layer even at very low weights per unit area, and therefore, the outer layer advantageously has a weight per unit area of less than 400 g/m², preferably less than 300 g/m², more preferably less than 250 g/m². This is true especially if the fiber mixture of the outer layer contains fibers made of polyester, in particular polyethylene terephthalate, and/or made of oxidized polyacrylonitrile and/or viscose, in addition to the structural binder fibers. These fibers then serve as structural fibers in the outer layer.

In principle, it may be sufficient for the core layer to have an outer layer on only one of its two opposing outer surfaces. Preferably, however, the core layer has an outer layer on each of its two sides, thus the core layer is encased between two outer layers.

The core layer can be formed in a manner known per se, and can advantageously include glass fibers and/or mineral fibers and/or plastic fibers made from a plastic that has a higher melting or softening temperature than that of the matrix material, bound in a porous thermoplastic matrix.

The outer layer can directly adjoin the core layer, for example if the outer layer contains material that is compatible with or even identical to the matrix binder material of the core layer.

It is also possible, however, for an intermediate layer to be provided between the core layer and at least one outer layer. This intermediate layer may itself comprise tangled fibers or may be a solid film. Regardless of whether the intermediate layer is in the form of a tangled fiber web or a film, it preferably contains a thermoplastic, more preferably a thermoplastic that is compatible with both a material of the outer layer and a material of the core layer. Here again, a polyolefin, preferably polypropylene, is suitable, and can be used both as a sheath material in the outer layer and as a matrix material in the core layer.

The present invention further relates to an automotive component that comprises an LWRT material according to any of the preceding description or is made exclusively of such an LWRT material. This does not include insignificant small parts of the automotive component, such as fastening means for attaching the component to a larger structure.

An automotive component of this type may be a shielding component, for example, such as may be used on the underbody or in the fender of a motor vehicle. Shielding components in particular can be advantageously produced using the LWRT material discussed herein, due to the high stone impact protection that can be achieved even with a low weight per unit area.

It is therefore further preferable for an outer layer to form an outwardly exposed surface of the automotive component, so that this outwardly exposed surface can actually provide the advantageous stone impact protection or generally the mechanical impact protection on the automotive component.

These and other objects, aspects, features, refinements and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 is a rough schematic cross-sectional view of an LWRT material embodied according to the invention; and

FIG. 2 is a cross-sectional view of a bicomponent structural binder fiber, as is used in the outer layers of the LWRT material of FIG. 1.

### DESCRIPTION OF PREFERRED EMBODIMENTS

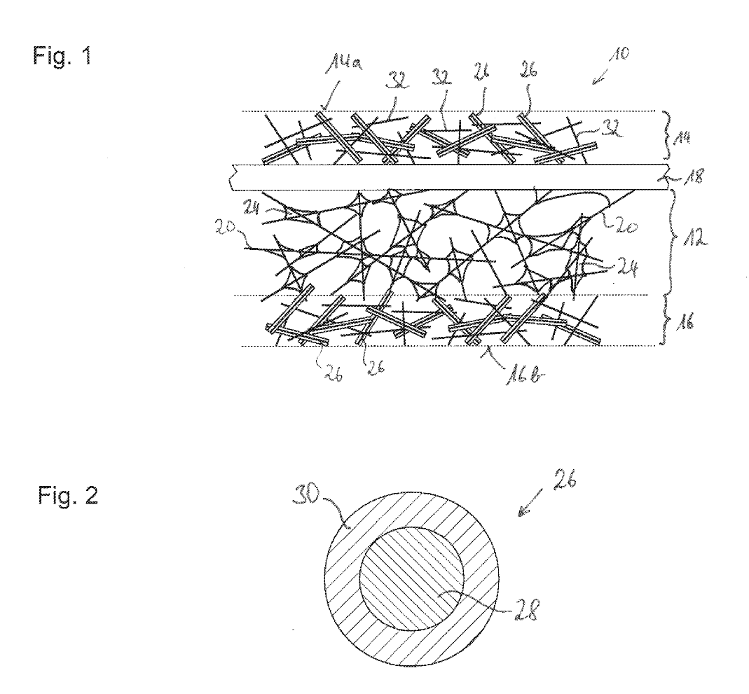

Referring now to the drawings wherein the showings are for the purpose of illustrating preferred and alternative embodiments of the invention only and not for the purpose of limiting the same, FIG. 1 shows an LWRT material according to the invention, depicted only roughly schematically in cross-section, that is labeled overall as 10. LWRT material 10 comprises a central core layer 12, a first outer layer 14 and a second outer layer 16. An intermediate layer 18, for example in the form of a polypropylene film, is provided between first outer layer 14 and core layer 12.

Core layer 12 is composed of a tangled web of structural fibers 20, bound to one another by a thermoplastic matrix 24. Core layer 12 is porous and is partially compacted in the finished state; the degree of compaction of the core layer may be different in situ, for example, core layer 12 may be more densely compressed in some areas than in others due to the formation of swage lines, etc. in the LWRT material 10.

The thermoplastic matrix 24 of core layer 12, in which polypropylene is preferably used as the matrix material, has been formed from a fiber mixture containing the thermally stable structural fibers 20 and polypropylene binder fibers, which are no longer present in the processing state shown in FIG. 1.

During processing, the LWRT material 10 has been heated to a temperature at which the binder material, in this case: polypropylene, is molten, so that the fiber structure of the initially present binder fibers is lost, but the structural fibers 20 remain dimensionally stable.

Core layer 12 can have a weight per unit area of 400 to 1200 g/m², depending on the intended use of the component produced from LWRT material 10.

Outer layers 14 and 16, the outer surfaces 14a and 16b of which can form the outer surfaces of LWRT material 10 overall, are substantially identical in structure; the following description will therefore refer only to first outer layer 14, but will apply to both outer layers 14 and 16.

Outer layer 14 contains bicomponent fibers 26 as structural binder fibers 26, as a constituent element. These are contained in the fiber mixture of the outer layer in a proportion of 10% to 50% by weight or 10% to 60% by weight.

Structural binder fibers 26 are formed from two components, as illustrated schematically in the cross-sectional diagram of FIG. 2.

Structural binder fiber 26 has a central fiber core 28 made of a fiber core material that remains dimensionally stable at temperatures at which the material of the sheath 30, which completely surrounds fiber core 28 in the circumferential direction and extends together with fiber core 28 in the longitudinal direction of the fiber, is molten.

The same material may be used as the sheath material for forming sheath 30 of structural binder fibers 26 as is used for forming matrix 24 of core layer 12, in this case: polypropylene. Fiber core 28 can be made of any material that melts at higher temperatures, but is preferably a polyester, such as polyethylene terephthalate.

In addition to structural binder fibers 26, outer layer 14 comprises other conventional fibers, such as single-component fibers 32, which may be identical to the structural fibers 20 of core layer 12, which may in turn be additionally or alternatively made of the same material from which the fiber cores 28 of structural binder fibers 26 are made. Moreover, the additional fibers 32 may be made of viscose and/or oxidized polyacrylonitrile and/or polyethylene terephthalate, to impart excellent stone impact resistance to outer layer 14 (and to outer layer 16).

The percentage by weight of conventional fibers 32, which are not structural binder fibers 26 in the outer layer, plus the percentage by weight of structural binder fibers 26 makes up 100% of the total fiber weight of outer layer 14.

Between outer layer 14 and core layer 12, an intermediate layer 18 may be provided, made of polypropylene, for example, so that intermediate layer 18 is compatible with the matrix material of matrix 24 in core layer 12 and with the sheath material of sheaths 30 of structural binder fibers 26, thereby facilitating the binding of layers 12, 18 and 14 to one another. Intermediate layer 18 may be made of any material, however. If necessary, it may be bonded to core layer 12 and/or to outer layer 14 by the additional provision of adhesion promoting materials.

Solely by way of example, no intermediate layer is provided here between core layer 12 and second outer layer 16, although an intermediate layer could also be provided there.

Because the selected materials are advantageously compatible: the material of matrix 24 on one hand and the sheath material of sheaths 30 of structural binder fibers 26 on the other hand, a bond can also be produced directly between core layer 12 and outer layer 16.

Since the above-mentioned compacting of core layer 12 is generally performed on the finished LWRT material 10, the compacting of outer layers 14 and 16 is the same as described above for core layer 12.

Outer layers 14 and/or 16 have a weight per unit area ranging from 180 to 400 g/m², depending on the intended application.

Since the sheath 30 of a structural binder fiber 26 retains its sheath structure even after being heated to above the melting point, no sheath material or only an insignificant amount of sheath material escapes through outer surface 14a during processing of the LWRT material 10, and as a result, the tendency of the exposed surface 14a of outer layer 14 to adhere to machining tools, in particular contact heating tools, is low to extremely low. LWRT material 10 can therefore be implemented without the otherwise customary provision of protective fleeces on the exposed outer surfaces 14a and 16b of LWRT material 10. The above description relating to surface 14a also applies to the likewise exposed outer surface 16b of LWRT material 10.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-13. (canceled)

14. An LWRT material having a core layer that comprises thermoplastically bound core structural fibers, and having at least one outer layer that comprises thermoplastically bound outer layer structural fibers, the at least one outer layer further comprises bicomponent fibers as structural binder fibers, the structural binder fibers having a fiber core made of a fiber core material with a predetermined fiber core melting or fiber core softening temperature, and a sheath surrounding the fiber core radially and made of a thermoplastic sheath material with a predetermined sheath melting or sheath softening temperature, the sheath melting or sheath softening temperature being lower than the fiber core melting or fiber core softening temperature, and the sheaths of the bicomponent fibers contributing to the thermoplastic binding of fibers in the at least one outer layer.

15. The LWRT material according to claim 14, wherein the fiber core material includes polyester.

16. The LWRT material according to claim 14, wherein the fiber core material is selected from the group consisting of a polyester, a polyethylene terephthalate, a polyacrylonitrile, an oxidized polyacrylonitrile, a cellulose, a viscose, a polyetheretherketone, a polystyrene, a glass, a quartz, a stone, a silica, and a metal.

17. The LWRT material according to claim 14, wherein the thermoplastically bound core structural fibers are formed from the same material as the thermoplastically bound outer layer structural fibers.

18. The LWRT material according to claim 14, wherein the sheath material is selected from the group consisting of a polyolefin, a polyamide and a polylactate.

19. The LWRT material according to claim 14, wherein the at least one outer layer has no thermoplastic binder material matrix.

20. The LWRT material according to claim 14, wherein the fibers of the at least one outer layer are thermoplastically bound solely by the sheaths of the structural binder fibers that are fused together.

21. The LWRT material according to claim 14, wherein no less than 10% by weight of a fiber weight contained in the at least one outer layer is the structural binder fibers.

22. The LWRT material according to claim 21, wherein no more than 60% by weight of the fiber weight contained in the at least one outer layer is the structural binder fibers.

23. The LWRT material according to claim 14, wherein no more than 60% by weight of a fiber weight contained in the at least one outer layer is the structural binder fibers.

24. The LWRT material according to claim 23, wherein no more than 50% by weight of the fiber weight contained in the at least one outer layer is the structural binder fibers.

25. The LWRT material according to claim 14, wherein the at least one outer layer has a weight per unit area of less than 400 g/m².

26. The LWRT material according to claim 14, wherein the weight per unit area is less than 300 g/m².

27. The LWRT material according to claim 14, wherein the at least one outer layer includes two outer layers, one provided on each side of the core layer.

28. The LWRT material according to claim 14, wherein the thermoplastically bound core structural fibers includes at least one of glass fibers, mineral fibers and plastic fibers made of a plastic that has a higher melting or softening temperature than that of a matrix material, bound in a porous thermoplastic matrix.

29. The LWRT material according to claim 14, further including an intermediate layer provided between the core layer and the at least one outer layer.

30. The LWRT material according to claim 29, wherein the intermediate layer includes at least one of a tangled fiber web, a film, a thermoplastic and a polyolefin.

31. An automotive component, in particular a shielding component, such as an underbody shield or fender skirt, comprising an LWRT material according to claim 14.

32. The automotive component according to claim 31, wherein one of the at least one outer layer forms an outwardly exposed surface of the automotive component.
